(19) United States
(12) Patent Application Publication
(10) Pub. No.: US 2014/0210707 A1
(43) Pub. Date: Jul. 31, 2014

(54) IMAGE CAPTURE SYSTEM AND METHOD

(71) Applicant: Leap Motion, Inc., San Francisco, CA (US)

(72) Inventor: David Holz, San Francisco, CA (US)

(73) Assignee: Leap Motion, Inc., San Francisco, CA (US)

(21) Appl. No.: 14/151,394

(22) Filed: Jan. 9, 2014

Related U.S. Application Data
(60) Provisional application No. 61/756,808, filed on Jan. 25, 2013.

(51) Int. Cl. G06F 3/01

(52) U.S. Cl. CPC G06F 3/017
USPC 345/156

(57) ABSTRACT

An example of an image capture system includes a support structure and a sensor arrangement, mounted to the support structure, including an image sensor, a lens, and a drive device. The image sensor has a sensor surface with a sensor surface area. The lens forms a focused image generally on the sensor surface. The area of the focused image is larger than the sensor surface area. The drive device is operably coupled to a chosen one of the lens and the image sensor for movement of the chosen one along a path parallel to the focused image. A portion of the viewing area including the object can be imaged onto the sensor surface and image data of the object, useful to determine information about the object, can be created by the image sensor to determine information regarding the object.

### CROSS-REFERENCE TO OTHER APPLICATIONS

This application claims the benefit of U.S. provisional patent application No. 61/756,808, filed 25 Jan. 2013, and entitled Display-Borne Optical System for Variable Field-of-View Imaging.

### FIELD OF THE INVENTION

The present invention relates, in general, to capturing the motion of objects in three-dimensional (3D) space, and in particular to motion-capture systems integrated within displays.

### BACKGROUND

Motion-capture systems have been deployed to facilitate numerous forms of contact-free interaction with a computer-driven display device. Simple applications allow a user to designate and manipulate on-screen artifacts using hand gestures, while more sophisticated implementations facilitate participation in immersive virtual environments, e.g., by waving to a character, pointing at an object, or performing an action such as swinging a golf club or baseball bat. The term “motion capture” refers generally to processes that capture movement of a subject in 3D space and translate that movement into, for example, a digital model or other representation.

Most existing motion-capture systems rely on markers or sensors worn by the subject while executing the motion and/or on the strategic placement of numerous cameras in the environment to capture images of the moving subject from different angles. As described in U.S. Ser. Nos. 13/414,485 (filed on Mar. 7, 2012) and 13/724,357 (filed on Dec. 21, 2012), the entire disclosures of which are hereby incorporated by reference, newer systems utilize compact sensor arrangements to detect, for example, hand gestures with high accuracy but without the need for markers or other worn devices. A sensor may, for example, lie on a flat surface below the user's hands. As the user performs gestures in a natural fashion, the sensor detects the movements and changing configurations of the user's hands, and motion-capture software reconstructs these gestures for display or interpretation.

In some deployments, it may be advantageous to integrate the sensor with the display itself For example, the sensor may be mounted within the top bezel or edge of a laptop's display, capturing user gestures above or near the keyboard. While desirable, this configuration poses considerable design challenges. As shown in FIG. 1A, the sensor's field of view θ must be angled down in order to cover the space just above the keyboard, while other use situations—e.g., where the user stands above the laptop—require the field of view θ to be angled upward. Large spaces are readily monitored by stand-alone cameras adapted for, e.g., videoconferencing; these can include gimbal mounts that permit multiple-axis rotation, enabling the camera to follow a user as she moves around. Such mounting configurations and the mechanics for controlling them are not practical, however, for the tight form factors of a laptop or flat-panel display.

Nor can wide-angle optics solve the problem of large fields of view because of the limited area of the image sensor; a lens angle of view wide enough to cover a broad region within which activity might occur would require an unrealistically large image sensor—only a small portion of which would be active at any time. For example, the angle Φ between the screen and the keyboard depends on the user's preference and ergonomic needs, and may be different each time the laptop is used; and the region within which the user performs gestures—directly over the keyboard or above the laptop altogether—is also subject to change.

Accordingly, there is a need for an optical configuration enabling an image sensor, deployed within a limited volume, to operate over a wide and variable field of view.

### SUMMARY

Embodiments of the present invention facilitate image capture and analysis over a variable portion of a wide field of view without optics that occupy a large volume. In general, embodiments hereof utilize lenses with image circles larger than the area of the image sensor, and optically locate image sensor in the region of the image circle corresponding to the desired portion of the field of view. As used herein, the term “image circle” refers to a focused image, cast by a lens onto the image plane, of objects located a given distance in front of the lens. The larger the lens's angle of view, the larger the image circle will be and the more visual information from the field of view it will contain. In this sense a wide-angle lens has a larger image circle than a normal lens due to its larger angle of view. In addition, the image plane itself can be displaced from perfect focus along the optical axis so long as image sharpness remains acceptable for the analysis to be performed, so in various embodiments the image circle corresponds the largest image on the image plane that retains adequate sharpness. Relative movement between the focusing optics and the image sensor dictates where within the image circle the image sensor is optically positioned—that is, which portion of the captured field of view it will record. In some embodiments the optics are moved (usually translated) relative to the image sensor, while in other embodiments, the image sensor is moved relative to the focusing optics. In still other embodiments, both the focusing optics and the image sensor are moved.

In a laptop configuration, the movement will generally be vertical so that the captured field of view is angled up or down. But the system may be configured, alternatively or in addition, for side-to-side or other relative movement.

Accordingly, in one aspect, the invention relates to a system for displaying content responsive to movement of an object in three-dimensional 3D space. In various embodiments, the system comprises a display having an edge; an image sensor, oriented toward a field of view in front of the display, within the edge; an assembly within the top edge for establishing a variable optical path between the field of view and the image sensor; and an image analyzer coupled to the image sensor. The image sensor may be configured to capture images of the object within the field of view; reconstruct, in real time, a changing position and shape of at least a portion of the object in 3D space based on the images; and cause the display to show content dynamically responsive to the changing position and shape of the object. In general, the lens has an image circle focused on the image sensor, and the image circle has an area larger than the area of the image sensor.

In some embodiments, the system further comprises at least one light source within the edge for illuminating the field of view. The optical assembly may comprise a guide, a lens and a mount therefor; the mount is slideable along the guide for movement relative to the image sensor. In some embodiments, the mount is bidirectionally slideable along the guide through a slide pitch defined by a pair of end points; a portion of the image circle fully covers the image sensor throughout the slide pitch. For example, the mount and the guide may be an interfitting groove and ridge. Alternatively, the guide may be or comprise a rail and the mount may be or comprise a channel for slideably receiving the rail therethrough for movement therealong.

In some implementations, the user may manually slide the mount along the guide. In other implementations, the system includes an activatable forcing device for bidirectionally translating the mount along the guide. For example, the forcing device may be a motor for translating the mount and fixedly retaining the mount at a selected position. Alternatively, the mount may be configured for frictional movement along the guide, so that the mount frictionally retains its position when the forcing device is inactive. In some implementations, the forcing device is or comprises a piezo element; in other implementations, the forcing device consists of or comprises at least one electromagnet and at least one permanent magnet on the mount.

The degree of necessary translation can be determined in various ways. In one embodiment, the image analyzer is configured to (i) detect an edge within the field of view and (ii) responsively cause the forcing device to position the mount relative to the detected edge. For example, the edge may be the forward edge of a laptop, and the desired field of view is established relative to this edge. In another embodiment, the image analyzer is configured to (i) cause the forcing device to translate the mount along the guide until movement of an object is detected, (ii) compute a centroid of the object and (iii) cause deactivation of the forcing device when the centroid is centered within the field of view. This process may be repeated periodically as the object moves, or may be repeated over a short time interval (e.g., a few seconds) so that an average centroid position can be computed from the acquired positions and centered within the field of view.

In another aspect, the invention relates to a method of displaying content on a display having an edge, where the displayed content is responsive to movement of an object in 3D space. In various embodiments, the method comprises the steps of varying an optical path between an image sensor, disposed within the edge, and a field of view in front of the display; operating the image sensor to capture images of the object within the field of view; reconstructing, in real time, a changing position and shape of at least a portion of the object in 3D space based on the images; and causing the display to show content dynamically responsive to the changing position and shape of the object. The optical path may be varied by moving a lens relative to the image sensor or by moving the image sensor relative to a lens. In some embodiments, an edge within the field of view is detected and the optical path positioned relative thereto. In other embodiments, the optical path is varied until movement of an object is detected, whereupon a centroid of the object is detected and used as the basis for the optical path, e.g., centering the centroid within the field of view.

As used herein, the term “substantially” or “approximately” means ±10% (e.g., by weight or by volume), and in some embodiments, ±5%. The term “consists essentially of” means excluding other materials that contribute to function, unless otherwise defined herein. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

The following detailed description together with the accompanying drawings will provide a better understanding of the nature and advantages of the present invention.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1A shows a side elevation of a laptop computer, which may include an embodiment of the present invention;

FIG. 1B is perspective front view of the laptop shown in FIG. 1A and including an embodiment of the present invention;

FIG. 2 is a simplified schematic depiction of an optical arrangement in accordance with embodiments of the invention.

FIGS. 3A, 3B and 3C are schematic elevations of various mounts and guides facilitating translational movement according to embodiments of the invention.

FIG. 3D is a cross-section of a mating mount and guide facilitating translational movement according to an embodiments of the invention.

FIG. 4 is a simplified illustration of a motion-capture system useful in conjunction with the present invention;

FIG. 5 is a simplified block diagram of a computer system that can be used to implement the system shown in FIG. 4.

### DETAILED DESCRIPTION

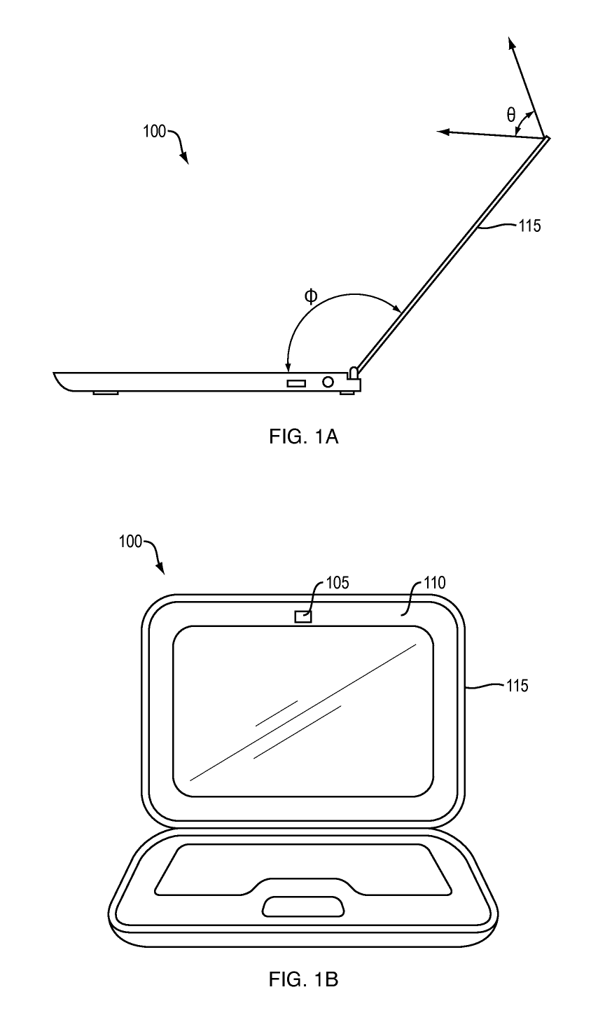

Refer first to FIGS. 1A and 1B, which illustrate both the environment in which the invention may be deployed as well as the problem that the invention addresses. A laptop computer 100 includes a sensor arrangement 105 in a top bezel or edge 110 of a display 115. Sensor arrangement 105 includes a conventional image sensor—i.e., a grid of light-sensitive pixels—and a focusing lens or set of lenses that focuses an image onto the image sensor. Sensor arrangement 105 may also include one or more illumination sources, and must have a limited depth to fit within the thickness of display 115. As shown in FIG. 1A, if sensor arrangement 105 were deployed with a fixed field of view, the coverage of its angle of view θ relative to the space in front of the laptop 100 would depend strongly on the angle Φ, i.e., where the user has positioned the display 115. Embodiments of the present invention allow the field of view defined by the angle θ to be angled relative to the display 115—typically around the horizontal axis of display 115, but depending on the application, rotation around another (e.g., vertical) axis may be provided. (The angle θ is assumed to be fixed; it is the field of view itself, i.e., the space within the angle θ, that is itself angled relative to the display.)

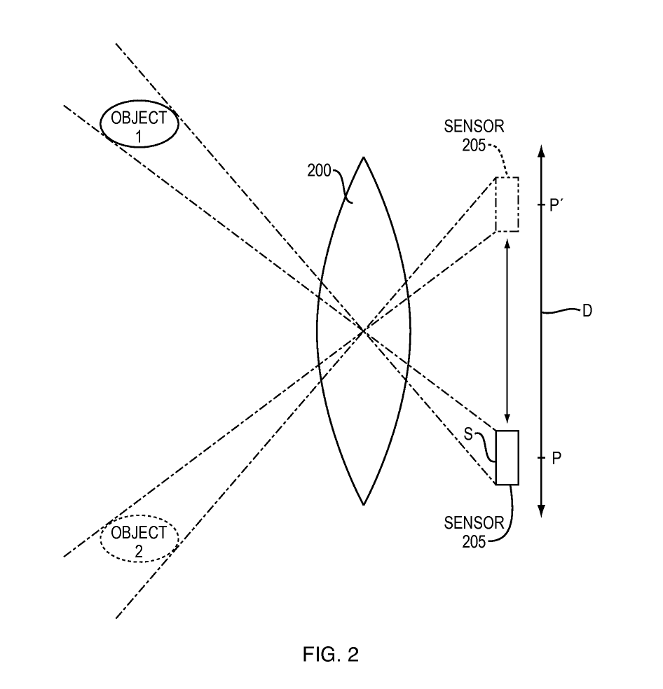

FIG. 2 illustrates in simplified fashion the general approach of the present invention. A focusing lens 200 produces an image circle having a diameter D. The image circle actually appears on an image plane defined by the surface of S of an image sensor 205. Lens 200 is typically (although not necessarily, depending on the expected distance for object detection) a wide-angle lens, and as a result produces a large image circle. Because the image-circle diameter D is so much larger than the area of sensor surface S, the image sensor 205 may translate from a first position P to a second position P′ while remaining within the image circle that is, throughout the excursion of image sensor 205 from P to P′, it remains within the image circle and illuminated with a portion of the focused image. (As noted above, the term “focused” means having sufficient sharpness for purposes of the image-analysis and reconstruction operations described below.) Translating image sensor from P to P′ means that different objects within the field of view will appear on image sensor 205. In particular, at position P, image sensor 205 will “see” Object 1, while at position P′ it will record the image of Object 2. It should be noted that Object 1 and Object 2 are equidistant from the image circle or close enough to equidistant to be within the allowed margin of focusing error. Those of skill in the art will appreciate that the same optical effect is achieved by moving lens 200 relative to a fixed image sensor 205. Furthermore, the illustrated optical arrangement is obviously simplified in that normal lens refraction is omitted.

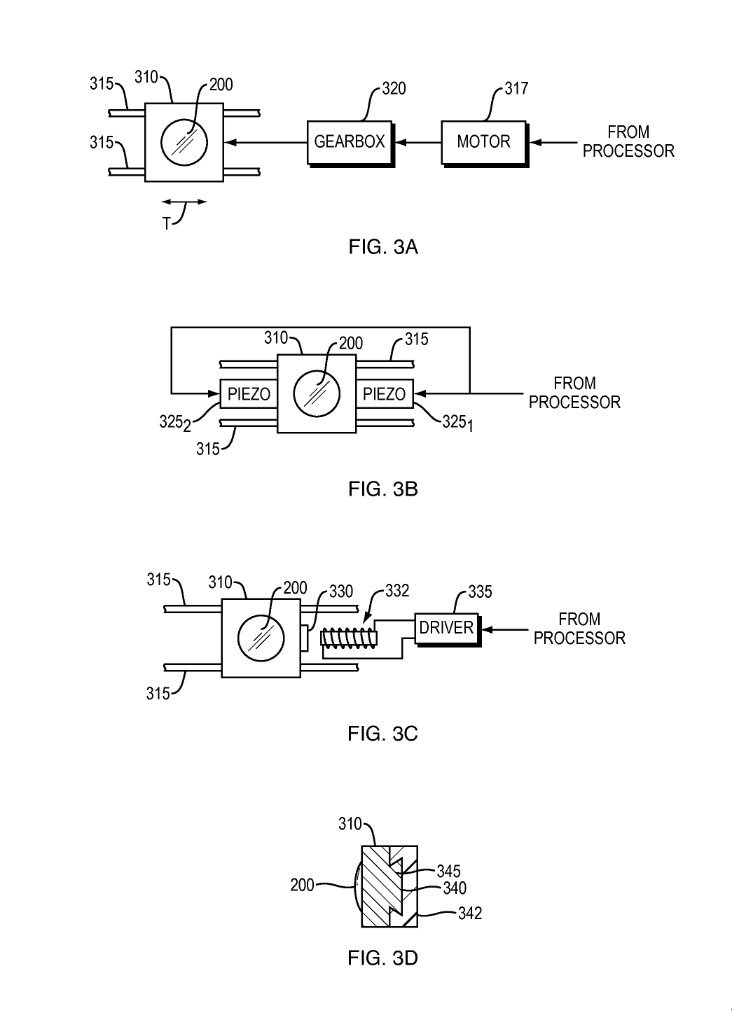

FIGS. 3A-3D illustrate various configurations for translating a lens 200 along a translation axis T. In a laptop, T will typically be vertical—i.e., along a line spanning and perpendicular to the top and bottom edges of the display 115 and lying substantially in the plane of the display (see FIGS. 1A and 1B)—but can be along any desired angle depending on the application. In FIGS. 3A-3C, the lens 200 is retained within a mount 310 that travels along one or more rails 315. In some embodiments, the rail is frictional (i.e., allows mount 310 to move therealong but with enough resistance to retain the mount 310 in any desired position). In other implementations, the system includes an activatable forcing device for bidirectionally translating the mount along the guide. In the embodiment shown in FIG. 3A, mount 310 is translated along rails 315 by a motor 317 (e.g., a stepper motor) 320 whose output is applied to mount 310 via a suitable gearbox 320. Deactivation of motor 317 retains mount 310 in the position attained when deactivation occurs, so the rails 315 need not be frictional. Operation of motor 317 is governed by a processor as described in detail below.

In the embodiment shown in FIG. 3B, one or more piezo elements 325₁, 325₂ are operated to move the mount 310 along the rails 315. The piezo elements 325 apply a directional force to mount 310 upon in response to a voltage. Although piezo actuators are capable of moving large masses, the distances over which they act tend to be small. Accordingly, a mechanism (such as a lever arrangement) to amplify the traversed distance may be employed. In the illustrated embodiment, the piezo elements 325₁, 325₂ receive voltages of opposite polarities so that one element contracts while the other expands. These voltages are applied directly by a processor or by a driver circuit under the control of a processor.

FIG. 3C illustrates an embodiment using a permanent magnet 330 affixed to mount 310 and an electromagnet 332, which is energized by a conventional driver circuit 335 controlled by a processor. By energizing the electromagnet 332 so that like poles of both magnets 330, 332 face each other, the lens mount 310 will be pushed away until the electromagnet 332 is de-energized, and mount 310 will retain its position due to the friction rails. To draw the mount 310 in the opposite direction, electromagnet 332 is energized with current flowing in the opposite direction so that it attracts permanent magnet 330.

In the embodiment shown in FIG. 3D, the guide is a grooved channel 340 within a longitudinal bearing fixture 342. In this case, mount 310 has a ridge 345 that slides within channel 340. As illustrated, ridge 345 may flare into flanges that retain mount 310 within complementary recesses in fixture 342 as the mount slides within the recessed channel of fixture 342. Although specific embodiments of the mount and guide have been described, it will be appreciated by those skilled in the art that numerous mechanically suitable alternatives are available and within the scope of the present invention.

In various embodiments of the present invention, the sensor interoperates with a system for capturing motion and/or determining position of an object using small amounts of information. For example, as disclosed in the '485 and '357 applications mentioned above, an outline of an object's shape, or silhouette, as seen from a particular vantage point, can be used to define tangent lines to the object from that vantage point in various planes, referred to as “slices.” Using as few as two different vantage points, four (or more) tangent lines from the vantage points to the object can be obtained in a given slice. From these four (or more) tangent lines, it is possible to determine the position of the object in the slice and to approximate its cross-section in the slice, e.g., using one or more ellipses or other simple closed curves. As another example, locations of points on an object's surface in a particular slice can be determined directly (e.g., using a time-of-flight camera), and the position and shape of a cross-section of the object in the slice can be approximated by fitting an ellipse or other simple closed curve to the points. Positions and cross-sections determined for different slices can be correlated to construct a 3D model of the object, including its position and shape. A succession of images can be analyzed using the same technique to model motion of the object. Motion of a complex object that has multiple separately articulating members (e.g., a human hand) can be modeled using techniques described herein.

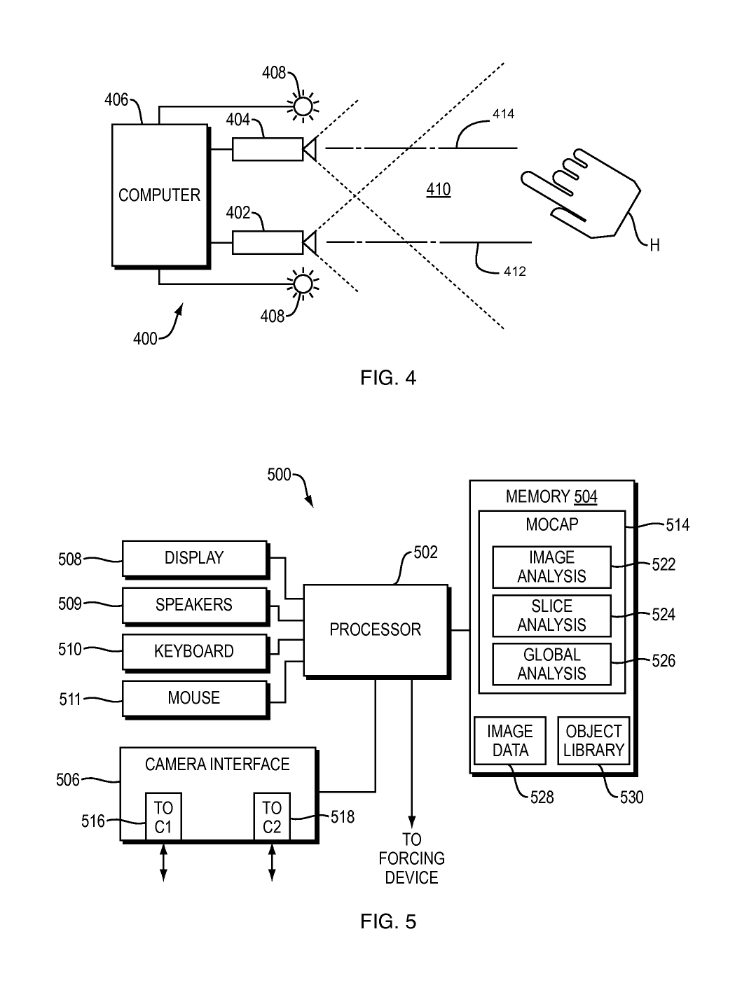

FIG. 4 is a simplified illustration of a motion-capture system 400 that is responsive to a sensor as described above. In this embodiment, the sensor consists of two cameras 402, 404 arranged such that their fields of view (indicated by broken lines) overlap in region 410. Cameras 402, 404 are coupled to provide image data to a computer 406. Computer 406 analyzes the image data to determine the 3D position and motion of an object, e.g., a hand H, that moves in the field of view of cameras 402, 404. The system 400 may also include one or more light sources 408 (disposed, along with the image sensor and focusing optics, within the display edge) for illuminating the field of view.

Cameras 402, 404 can be any type of camera, including visible-light cameras, infrared (IR) cameras, ultraviolet cameras or any other devices (or combination of devices) that are capable of capturing an image of an object and representing that image in the form of digital data. Cameras 402, 404 are preferably capable of capturing video images (i.e., successive image frames at a constant rate of at least 15 frames per second), although no particular frame rate is required. The sensor can be oriented in any convenient manner. In the embodiment shown, respective optical axes 412, 414 of cameras 402, 404 are parallel, but this is not required. As described below, each camera is used to define a “vantage point” from which the object is seen, and it is required only that a location and view direction associated with each vantage point be known, so that the locus of points in space that project onto a particular position in the camera's image plane can be determined. In some embodiments, motion capture is reliable only for objects in area 410 (where the fields of view of cameras 402, 404 overlap), which corresponds to the field of view θ in FIG. 1. Cameras 402, 404 may provide overlapping fields of view throughout the area where motion of interest is expected to occur.

Computer 406 can be any device capable of processing image data using techniques described herein. FIG. 5 depicts a computer system 500 implementing computer 406 according to an embodiment of the present invention. Computer system 500 includes a processor 502, a memory 504, a camera interface 506, a display 508, speakers 509, a keyboard 510, and a mouse 511. Processor 502 can be of generally conventional design and can include, e.g., one or more programmable microprocessors capable of executing sequences of instructions. Memory 504 can include volatile (e.g., DRAM) and nonvolatile (e.g., flash memory) storage in any combination. Other storage media (e.g., magnetic disk, optical disk) can also be provided. Memory 504 can be used to store instructions to be executed by processor 502 as well as input and/or output data associated with execution of the instructions.

Camera interface 506 can include hardware and/or software that enables communication between computer system 500 and the image sensor. Thus, for example, camera interface 506 can include one or more data ports 516, 518 to which cameras can be connected, as well as hardware and/or software signal processors to modify data signals received from the cameras (e.g., to reduce noise or reformat data) prior to providing the signals as inputs to a conventional motion-capture (“mocap”) program 514 executing on processor 502. In some embodiments, camera interface 506 can also transmit signals to the cameras, e.g., to activate or deactivate the cameras, to control camera settings (frame rate, image quality, sensitivity, etc.), or the like. Such signals can be transmitted, e.g., in response to control signals from processor 502, which may in turn be generated in response to user input or other detected events.

In some embodiments, memory 504 can store mocap program 514, which includes instructions for performing motion capture analysis on images supplied from cameras connected to camera interface 506. In one embodiment, mocap program 514 includes various modules, such as an image-analysis module 522, a slice-analysis module 524, and a global analysis module 526. Image-analysis module 522 can analyze images, e.g., images captured via camera interface 506, to detect edges or other features of an object. Slice-analysis module 524 can analyze image data from a slice of an image as described below, to generate an approximate cross-section of the object in a particular plane. Global analysis module 526 can correlate cross-sections across different slices and refine the analysis. Memory 504 can also include other information used by mocap program 514; for example, memory 504 can store image data 528 and an object library 530 that can include canonical models of various objects of interest. As described below, an object being modeled can be identified by matching its shape to a model in object library 530.

Display 508, speakers 509, keyboard 510, and mouse 511 can be used to facilitate user interaction with computer system 500. These components can be of generally conventional design or modified as desired to provide any type of user interaction. In some embodiments, results of motion capture using camera interface 506 and mocap program 514 can be interpreted as user input. For example, a user can perform hand gestures that are analyzed using mocap program 514, and the results of this analysis can be interpreted as an instruction to some other program executing on processor 500 (e.g., a web browser, word processor or the like). Thus, by way of illustration, a user might be able to use upward or downward swiping gestures to “scroll” a webpage currently displayed on display 508, to use rotating gestures to increase or decrease the volume of audio output from speakers 509, and so on.

With reference to FIGS. 4 and 5, processor 402 also determines the proper position of the lens and/or image sensor, which determines the angle at which the field of view 410 is directed. The necessary degree of translation of, for example, the lens can be determined in various ways. In one embodiment, image-analysis module 522 detects an edge within the image of the field of view and computes the proper angle based on the position of the edge. For example, in a laptop configuration, the forward edge of the laptop may define the lower extent of the field of view 410, and processor 502 (e.g., via image-analysis module 522) sends signals to the translation mechanism (or its driver circuitry) to move the lens mount until the lower boundary of field of view 410 intercepts the edge. In another embodiment, image-analysis module 522 operates the forcing device to translate the lens mount along the guide, varying the optical path to the image sensor until movement of an object is detected in the field of view 410. Image-analysis module 522 computes the centroid of the detected object and causes deactivation of the forcing device when the centroid is centered within the field of view 410. This process may be repeated periodically as the object moves, or may be repeated over a short time interval (e.g., a few seconds) so that an average centroid position can be computed from the acquired positions and centered within the field of view. In general, a portion of the image circle will fully cover the image sensor throughout the end-to-end sliding movement of the lens and/or image sensor.

It will be appreciated that computer system 500 is illustrative and that variations and modifications are possible. Computers can be implemented in a variety of form factors, including server systems, desktop systems, laptop systems, tablets, smart phones or personal digital assistants, and so on. A particular implementation may include other functionality not described herein, e.g., wired and/or wireless network interfaces, media playing and/or recording capability, etc. In some embodiments, one or more cameras may be built into the computer rather than being supplied as separate components. Furthermore, while computer system 500 is described herein with reference to particular blocks, it is to be understood that the blocks are defined for convenience of description and are not intended to imply a particular physical arrangement of component parts. Further, the blocks need not correspond to physically distinct components. To the extent that physically distinct components are used, connections between components (e.g., for data communication) can be wired and/or wireless as desired.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. An image capture system comprising:
a support structure;
a sensor arrangement, mounted to the support structure, comprising an image sensor, a lens, and a drive device;
the image sensor having a sensor surface, the sensor surface having a sensor surface area;
the lens forming a focused image generally on the sensor surface, the focused image having an focused image area;
the focused image area being larger than the sensor surface area; and
the drive device operably coupled to a chosen one of the lens and the image sensor for movement of the chosen one along a path parallel to the focused image.

2. The system according to claim 1, wherein the support structure comprises a computer display.

3. The system according to claim 1, wherein the support structure comprises an edge of a computer display.

4. The system according to claim 1, wherein the lens is mounted to the support structure through the drive device.

5. The system according to claim 4, wherein the drive device comprises a lens mount, to which the lens is secured, and guide structure on which the lens mount is slideably mounted.

6. The system according to claim 4, wherein the guide structure comprises at least one of parallel rails and an elongate bearing element, the elongate bearing element comprising a guide channel.

7. The system according to claim 1, wherein the chosen one of the lens and the image sensor is mounted to the support structure through the drive device.

8. The system according to claim 1, wherein the focused image area is much larger than the sensor surface area.

9. The system according to claim 1, wherein the focused image fully covers the sensor surface during movement of the chosen one along the path.

10. The system according to claim 1, further comprising an illumination source associated with the image sensor and mounted to the support structure.

11. The system according to claim 10, wherein the illumination source is an infrared light source.

12. The system according to claim 10, further comprising first and second of said image sensors and first and second of said illumination sources.

13. The system according to claim 1, wherein said path is a generally vertical path.

14. The system according to claim 1, wherein the drive device comprises a chosen one of a drive motor, a piezoelectric driver, and an electromagnetic driver.

15. The system according to claim 1, wherein the drive device is operably coupled to the lens.

16. A method for capturing an image of an object at a portion of a field of view comprising:
directing a sensor arrangement, mounted to a support structure, towards a viewing area containing an object, the sensor arrangement, comprising an image sensor and a lens, the image sensor having a sensor surface, the sensor surface having a sensor surface area, the lens forming a focused image generally on the sensor surface, the focused image having an focused image area, the focused image area being larger area than the sensor surface area;
moving a chosen one of the lens and the image sensor along a path parallel to the focused image, the path extending between a first position and a second position;
imaging a portion of the viewing area including the object onto the sensor surface;
creating image data of the object by the image sensor;
using the image data to determine information regarding the object.

17. The method according to claim 16, wherein the sensor arrangement comprises a drive device, drive device comprising a lens mount, to which the lens is secured, and guide structure on which the lens mount is slideably mounted, and wherein the moving step comprises moving the lens mount with the lens secured thereto along the guide structure.

18. The method according to claim 16, wherein the portion of the viewing area imaging step comprises imaging at least a portion of a user's hand as the object.

19. The method according to claim 18, wherein the image data using step comprises matching a hand gesture to a model hand gesture corresponding to an instruction.

20. The method according to claim 16, wherein the image data using step is carried out using a processor.

21. A system for displaying content responsive to movement of an object in three-dimensional (3D) space, the system comprising:
a display having an edge;
an image sensor, oriented toward a field of view in front of the display, within the edge;
an assembly within the top edge for establishing a variable optical path between the field of view and the image sensor; and
an image analyzer coupled to the image sensor and configured to:
capture images of the object within the field of view;
reconstruct, in real time, a changing position and shape of at least a portion of the object in 3D space based on the images; and
cause the display to show content dynamically responsive to the changing position and shape of the object.

22. The system of claim 21, further comprising at least one light source within the edge for illuminating the field of view.

23. The system of claim 21, wherein the lens has an image circle focused on the image sensor, the image circle having an area larger than an area of the image sensor.

24. The system of claim 23, wherein the optical assembly comprises a guide, a lens and a mount therefor, the mount being slideable along the guide for movement relative to the image sensor.

25. The system of claim 24, wherein the mount is bidirectionally slideable along the guide through a slide pitch defined by a pair of end points, a portion of the image circle fully covering the image sensor throughout the slide pitch.

26. The system of claim 24, wherein the mount and the guide each comprise one of a groove or a ridge.

27. The system of claim 24, wherein the guide comprises a rail and the mount comprises a channel for slideably receiving the rail therethrough for movement therealong.

28. The system of claim 24, further comprising an activatable forcing device for bidirectionally translating the mount along the guide.

29. The system of claim 28, wherein the forcing device is a motor for translating the mount along the guide and fixedly retaining the mount at a selected position therealong.

30. The system of claim 28, wherein the mount is configured for frictional movement along the guide, the mount frictionally retaining its position along the guide when the forcing device is inactive.

31. The system of claim 30, wherein the forcing device comprises a piezo element.

32. The system of claim 30, wherein the forcing device comprises (i) at least one electromagnet and (ii) at least one permanent magnet on the mount.

33. The system of claim 28, wherein the image analyzer is configured to (i) detect an edge within the field of view and (ii) responsively cause the forcing device to position the mount relative to the detected edge.

34. The system of claim 28, wherein the image analyzer is configured to (i) cause the forcing device to translate the mount along the guide until movement of an object is detected, (ii) compute a centroid of the object and (iii) cause deactivation of the forcing device when the centroid is centered within the field of view.

35. A method of displaying content on a display having an edge, the content being responsive to movement of an object in three-dimensional (3D) space, the method comprising the steps of:
varying an optical path between an image sensor, disposed within the edge, and a field of view in front of the display,
operating the image sensor to capture images of the object within the field of view;
reconstructing, in real time, a changing position and shape of at least a portion of the object in 3D space based on the images; and
causing the display to show content dynamically responsive to the changing position and shape of the object.

36. The method of claim 35, wherein the optical path is varied by moving a lens relative to the image sensor.

37. The method of claim 35, wherein the optical path is varied by moving the image sensor relative to a lens.

38. The method of claim 35, further comprising the steps of (i) detecting an edge within the field of view and (ii) responsively positioning the optical path relative to the detected edge.

39. The method of claim 35, further comprising the steps of (i) varying the optical path until movement of an object is detected, (ii) computing a centroid of the object and (iii) centering the centroid within the field of view.
